(19) United States
(12) Patent Application Publication
(10) Pub. No.: US 2013/0193121 A1
(43) Pub. Date: Aug. 1, 2013

(54) Device and Method for Continuously Welding Strips and/or Sheets

(71) Applicant: Gerhard Alber, Berg (DE)

(72) Inventor: Gerhard Alber, Berg (DE)

(73) Assignee: THYSSENKRUPP LASERTECHNIK GMBH, Ravensburg (DE)

(21) Appl. No.: 13/578,028

(22) PCT Filed: Feb. 2, 2011
(86) PCT No.: PCT/EP11/51426

§ 371 Date: Oct. 30, 2012

(30) Foreign Application Priority Data
Feb. 10, 2010 (DE) 10 2010 007 573.6

(51) Int. Cl. B23K 26/00

(52) U.S. Cl. CPC B23K 26/00
USPC 219/121.62

(57) ABSTRACT

A method and to a corresponding device for continuously welding strips or sheets, guided into abutment, at their abutting edges, comprising at least two welding heads, and tension rollers which are arranged in pairs on both sides of the strips or sheets to be welded perpendicularly to the running direction thereof and which form a gap in the region of a joint of the strips or sheets, through which gap a first energy beam emanating from a first of the at least two welding heads impacts the strip edges or longitudinal edges to be welded, a second of the at least two welding heads being arranged on the opposite side of the strips or sheets a second energy beam of said second welding head impacting in this location the strip edges or longitudinal edges to be welded, characterised in that wherein the at least two welding heads are arranged offset relative to one another in the running direction of the strips or sheets so that the impact points of the energy beams on the strip edges or longitudinal edges to be welded are spaced apart from one another at least by the measurement of half the external diameter of the tension roller facing the first energy beam.

The invention relates to a device and to a method for continuously welding strips or sheets, guided into abutment, at their abutting edges by means of at least two welding heads, in particular laser welding heads, and tension rollers which are arranged in pairs on both sides of the strips or sheets to be welded, perpendicularly to the running direction thereof, and which form a gap in the region of the joint of the strips or sheets, through which gap an energy beam emanating from the first of the at least two welding heads impacts the strip edges or longitudinal edges to be welded, a second of the at least two welding heads being arranged on the opposite side of the strips or sheets, the energy beam of which impacting in this location the strip edges or longitudinal edges to be welded.

A device of this type is known from DE 37 23 611 C2. The device operates with at least one laser beam. The tension rollers thereof consist of hollow axles and roller mantles which are mounted thereon and are arranged at an axial distance from one another, each laser beam welding head being arranged inside the hollow axle of at least one tension roller. The gap between the roller mantles and an opening in the hollow axle are used as a passage for the laser beam. It is stated in DE 37 23 611 C2 that it usually suffices for a single welding head to be provided in one of the two opposing tension rollers. However, in respect of the welding of particularly thick sheets or strips, it is also proposed there as an advantageous configuration with regard to the energy required for this purpose to provide at least one welding head in each of the tension rollers arranged on both sides of the strips or sheets and/or to arrange a plurality of welding heads offset relative to one another in the running direction of the strip in one tension roller arranged on one side of the strip.

Furthermore, a method for welding metal components is described in DE 101 31 883 B4 in which the metal components are fused in the weld seam region on both sides by means of at least one respective welding beam, in particular a laser beam in the heat conduction mode over substantially the entire weld seam cross section, a relative movement taking place between the metal components and the welding beam, and the weld pool regions of the welding beams which act on opposite sides of the metal components being produced such that they at least partly overlap by means of a corresponding relative arrangement of the positions of the welding beams in the weld seam direction.

When coated car body sheets ranging in thickness from 0.6 mm to 3.0 mm are welded by a laser beam which acts on the upper side of the sheets, a considerable amount of dirt is produced particularly on the side of the sheet remote from the laser welding head. The dirt particles are blasted off downwards with high dynamics. In existing welding installations according to DE 37 23 611 C2, this dirt is collected by water-cooled beam traps or suction means. However, in practice, some dirt is left behind so that from time to time a manual cleaning operation is required to remove the accumulated dirt.

A further problem in the continuous welding of sheets in an installation according to DE 37 23 611 C2 is that the sheets to be welded have a gap. The gap width is, for example, up to approximately 0.2 mm. Although the gap is very narrow, a relatively large proportion of the laser radiation can pass through the gap during welding. Thus, an opposite second welding head would be exposed to a constant laser beam bombardment during welding and would therefore have to be protected in a suitable manner. This problem is exacerbated by the fact that, in a production plant, it is impossible to activate and deactivate the laser radiation in a precise manner at the beginning and at the end of the sheet due to reaction times in the control and to tolerances in the sheet and in the welding machine. This means that possibly in each case at the start and at the end of the welding procedure, the full laser power shoots downwards past the sheets to be welded. Therefore, an opposing arrangement of two welding points or laser welding heads is difficult to realise technically in a continuous welding installation according to DE 37 23 611 C2.

The object of the present invention is to provide a device and a method for continuously welding strips which are guided such that they are abutting, which device and method allow the production of a uniform and relatively smooth weld seam, even in the case of thin strips or sheets, and this at a significantly higher welding speed than achieved by conventional welding installations of this type.

This object is achieved according to the invention by a device having the features of claim 1 and by a method having the features of claim 8.

The device according to the invention comprises at least two welding heads which are arranged offset relative to one another on both sides of the strips or sheets to be welded and in the running direction of the strips or sheets, so that the impact points of the welding beams (energy beams) on the strip edges or longitudinal edges to be welded are spaced apart by at least the measurement of half the external diameter of the tension roller facing the first energy beam.

The spacing of the bilateral welding sites is thus calculated to be large enough so that the second of the at least two welding heads is not arranged in the tension roller surrounding the first welding head or in the tension roller opposite the above-mentioned tension roller.

Accordingly, the method of the invention is characterised in that the at least two welding heads are arranged offset relative to one another in the running direction of the strips or sheets so that the impact points of the energy beams on the strip edges or longitudinal edges to be welded are spaced apart at least by the measurement of half the external diameter of the tension roller facing the first energy beam, and in that the energy beam outputs of the at least two welding heads are adjusted such that the weld pool penetration depth, produced by the respective energy beam, does not extend beyond a partial thickness of the strips or sheets to be welded or, in the case of strips or sheets with different thicknesses, does not extend beyond a partial thickness of the thinner of the strips or sheets to be welded.

The device according to the invention and the corresponding sequential welding method allow a continuous welding of strips or sheets, guided into abutment, at the abutting edges at a high welding speed. In this respect, uniform and relatively smooth weld seams can be produced even in the case of thin strips or sheets. In corresponding welding tests on steel sheets having a thickness of approximately 0.8 mm and 1.5 mm, it was possible, with identical laser beam outputs, to increase laser speeds compared to the conventional unilateral method, even to almost double these speeds and to achieve speeds of more than 15 m/min. The weld seams produced thus had a uniform and smooth surface.

A further advantage of the arrangement of the welding sites according to the invention in a spacing which corresponds at least to the measurement of half the external diameter of the tension roller facing the first energy beam is that due to this spatial separation, two separate welding processes take place in practice and there is no superposition of two processes at one point (in one region). Consequently, this substantially facilitates the adjustment and optimisation of the process parameters.

A further configuration of the device according to the invention provides that the welding heads of said device are arranged such that the impact points of their energy beams on the strip edges or longitudinal edges to be welded are spaced apart from one another by an amount within a range of 15 cm to 200 cm, preferably within a range of 50 cm to 120 cm.

A further advantageous configuration of the device according to the invention is characterised in that the tension roller engaging on the lower side of the strips or sheets is configured, for example, as a spoked wheel construction and has roller mantles which are arranged in an axial spacing from one another. When tailored blanks or corresponding strips of metal strips having different material characteristics and/or thicknesses are welded, a very high degree of accuracy in respect of the so-called vertical linear misalignment is desired. During continuous welding in an installation according to DE 37 23 611 C2, in particular the lower roller (base roller) is subjected to a considerable thermal load. Configuring the tension roller as a spoked wheel substantially improves the dimensional stability of the tension roller, so that the thermal load does not lead to distortion of the tension roller and to tolerances resulting therefrom in respect of linear misalignment. Other configurations of the tension rollers are also possible.

A further advantageous configuration of the device according to the invention provides that roller supports with driver rollers for conveying the strips or sheets to be welded are arranged next to the tension rollers. This configuration allows a very precise control of the feed of the strips or sheets relative to the welding heads. In this connection, the invention further provides that the roller supports are mounted movably and are provided with at least one drive by which the roller supports can be moved parallel to the axes of rotation of the tension rollers. This makes it possible to adjust the position of the strip edges or longitudinal edges to be welded relative to the tension rollers and to the axis of the energy beam. The adjustment can be made by a corresponding control of the drive associated with the movable roller support. An advantageous development of this configuration provides a sensor, connected to a control means, for detecting the position of the strip edges or longitudinal edges to be welded, the control means controlling the drive of the roller supports subject to the position, detected by the sensor, of the strip edges or longitudinal edges. This measure provides an automatic adjustment of the position of the strip edges or longitudinal edges to be welded relative to the axis of the energy beam.

Alternatively, chains with, for example, driving pins can also be used to convey the strips or sheets to be welded. Furthermore, in the device according to the invention, it is also possible to use conveyors which transport the strips or sheets to be welded to the impact points of the energy beams by clamping or tensioning means.

A further advantageous configuration of the welding method according to the invention is that the at least two welding heads are operated with a different energy beam output subject to the material, the thickness and/or the feed rate of the strips or sheets to be welded, thereby producing different penetration depths of the weld pool regions on both sides of the strips or sheets to be welded. The energy beam outputs or penetration depths of the weld pool regions can be selected such that when coated metal sheets are welded, for example, welding particles (particles of dirt) are for the most part prevented from being blasted off. In this respect, in particular the energy beam outputs or penetration depths of the weld pool regions can be selected such that an adequately strong weld is already produced by the first of the at least two energy beams (laser beams), which weld subsequently prevents an undesired vertical linear misalignment.

In this connection, the method according to the invention provides in particular that, with the first welding head and the at least one second welding head, weld pool penetration depths are produced which overlap by at least 10%, preferably by at least 20%, the same energy preferably being input at both impact points of the energy beams. Depending on the thickness and/or material quality of the strips or sheets to be welded, the welding speed can be almost doubled as a result of this configuration of the method according to the invention.

In the following, the invention will be described in more detail with reference to drawings representing a plurality of embodiments. In the schematic drawings:

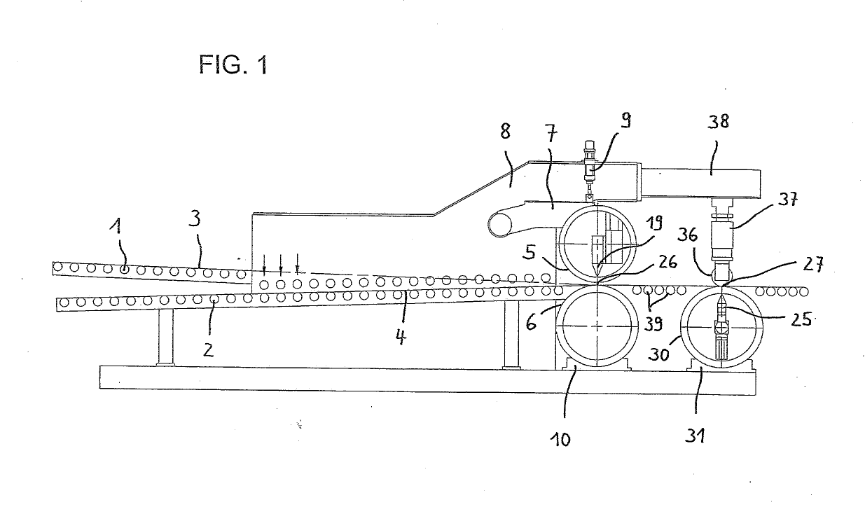

FIG. 1 is a side view of a welding device according to the invention comprising a first tension roller station and a second tension roller station which follows in the running direction of the strip;

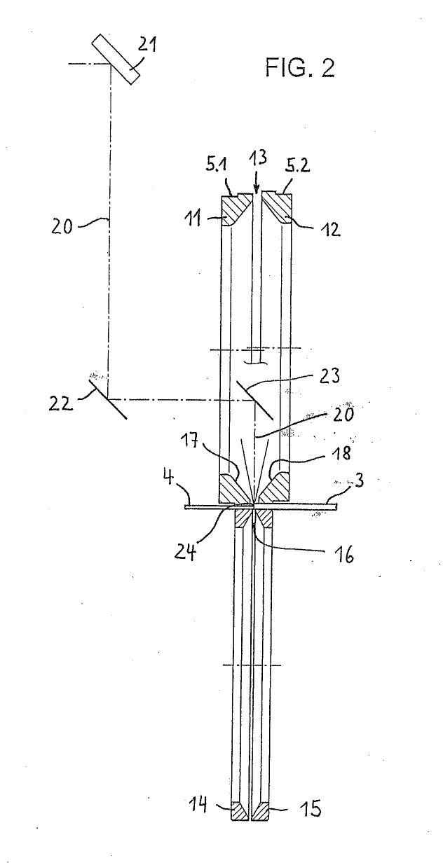

FIG. 2 is a vertical sectional view of the first tension roller station of the welding device of FIG. 1, where the upper tension rollers are provided with a laser welding means;

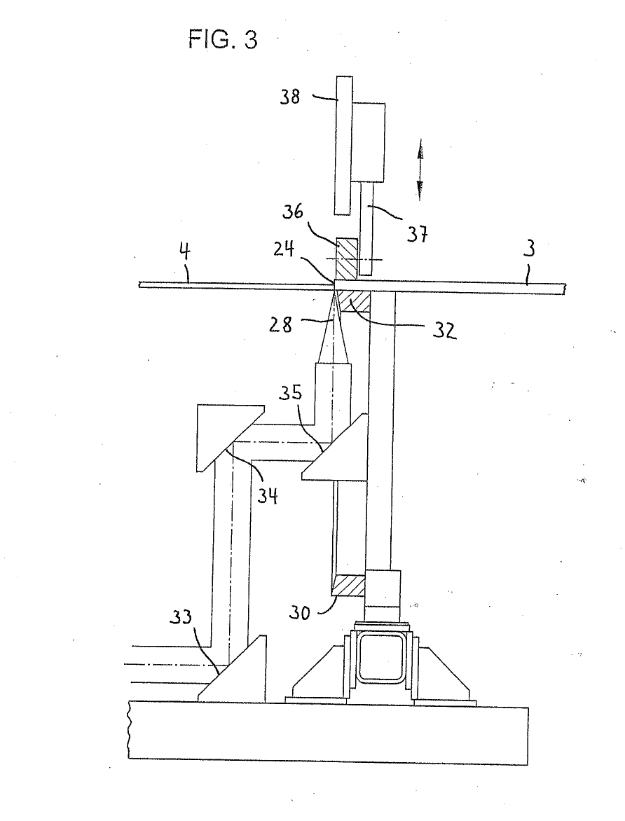

FIG. 3 is a vertical sectional view of the second tension roller station of the welding device of FIG. 1, where the lower tension roller is provided with second laser welding means;

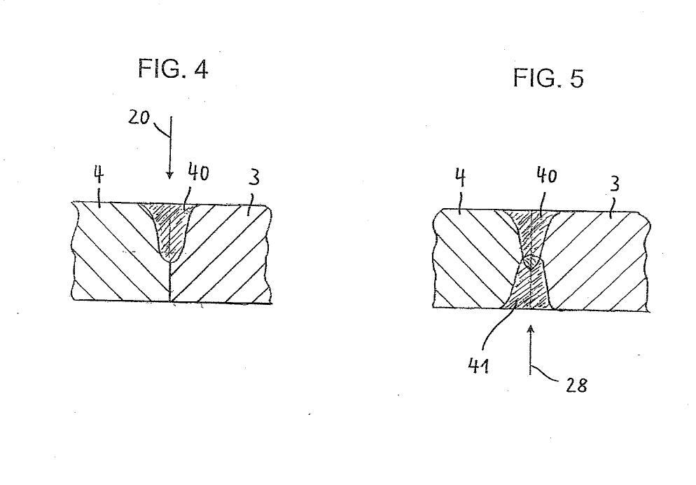

FIG. 4 is a vertical sectional view of a portion of two strips or sheets welded together at their abutting edges with a first welding carried out from above; and

FIG. 5 is again a vertical sectional view of the portion of the strips or sheets of FIG. 4 with a second welding carried out from below.

The device (installation) shown in FIG. 1 comprises guide means 1, 2, formed from roller conveyors, by which two sheets or strips 3, 4 which are to be welded together are guided together at an acute angle such that they abut with their mutually facing edges in the region between two tension rollers 5, 6. The upper tension roller 5 is mounted pivotally on a machine gantry 8 by a rocker 7 and is thus mounted in a vertically adjustable manner with respect to the lower tension roller 6. A hydraulically operable actuating cylinder 9, which is also attached to the machine gantry 8, is used to adjust the height of the tension roller 5.

The upper tension roller 5 is mounted in a freely rotatable manner on the rocker 7, while the lower tension roller 6, mounted in a bearing block 10, is preferably driven by a drive which is not shown in the drawing. The rocker 7 has two arms which can pivot independently of one another and which each support a half 5.1, 5.2 of the tension roller 5 (cf. FIG. 2). This allows an adjustment to sheets or strips 3, 4 of different thicknesses.

The upper tension rollers 5.1, 5.2 each have a hollow axle (not shown) with a roller mantle 11, 12 mounted in ball bearings thereon. The roller mantles 11, 12 are arranged in an axial spacing from one another and form between them a gap 13. The upper hollow axle is divided in the region of the gap 13 to form a corresponding gap, while the lower tension roller (base roller) 6 is configured as a spoked wheel construction and has roller mantles 14, 15 arranged in an axial spacing from one another. The spoked wheel construction (not shown in more detail) of the lower tension roller 6 is mounted rotatably on a substantially continuous hollow axle (not shown). In the upper region, the hollow axle has an opening which faces the gap 16 between the lower roller mantles 14, 15 and in which a removal device (not shown) is arranged for removing welding fumes and/or blasted-off welding particles (dirt particles). Furthermore, a supply device (not shown) for inert gas is arranged in the lower tension roller 6 between the spoked wheel construction. Inert gas can be conveyed to the welding site via the supply device and the gap 16.

The edges 17, 18 of the upper roller mantles 11, 12 are bevelled all round. This configuration makes it possible to move the welding head 19 closely to the welding site. Provided in the axially divided hollow axle of the upper tension roller 5 is an adjusting drive which can move the welding head 19 of a laser welding means in three axes running perpendicularly to one another. The laser beam 20 is guided via an optical system having a plurality of deflection mirrors 21, 22, 23 into the welding head 20 which is provided with a focussing element (not shown), for example a focussing lens. Alternatively, in particular to reduce the number of parts, a fibre optic cable which is connected to an Nd-YAG laser can be used to couple the energy output. To control the adjusting drive, a measuring means for monitoring the weld groove can be provided, which measuring means can consist, for example, of a radiation source, in particular a laser, and a sensor, in particular a diode line camera. The signals from the sensor are supplied to an evaluation means which determines the size and/or position of the weld gap (joint) with respect to desired position and/or desired width and, when there is a difference between the desired value and the actual value, it sends control pulses to the adjusting drive which adjusts the welding head 19 accordingly. The conical widening 17, 18 of the inner circumference of the upper roller mantles 11, 12 towards their mutually facing sides, which define the gap 13, allows an oblique orientation of the laser beam 20 onto the joint, without the laser beam 20 being obstructed by one of the roller mantles 11, 12. An oblique orientation of the laser beam 20 is usual when strips of different thicknesses are welded. However, when sheets or strips of the same thickness are welded, the laser beam 20 is usually directed perpendicularly onto the joint 24.

The welding device illustrated in FIG. 1 is also provided with a second welding head 25 which is arranged offset relative to the first welding head 19 on the lower side of the strips 3, 4 and in the running direction of the strips 3, 4. The two welding heads 19, 25 are arranged relative to one another such that the impact points 26, 27 of their laser beams 20, 28 on the strip edges or longitudinal edges to be welded are spaced apart from one another for example by approximately 800 mm to 1200 mm, preferably by 900 mm to 1000 mm.

The second welding head 25 is provided in a tension roller 30 which follows in the running direction of the strips 3, 4 and is mounted in a freely rotatable manner in a stationary bearing block 31. Tension roller 30 also has a hollow axle with a roller mantle 32 mounted in ball bearings thereon. The side of the roller mantle 32 facing the laser beam 28 is also configured to be conical, so that the laser beam 28 can be oriented obliquely onto the joint 24 without being obstructed by the roller mantle, if there is a gradation (varying thickness) on the lower side of the strips 3, 4 or sheets to be welded. However, in FIG. 3, the lower sides of the strips 3, 4 to be welded are located in one plane, so that the laser beam 28 is oriented perpendicularly onto the joint 24 or onto the strips 3, 4. The laser beam 28 generated by a resonator (not shown) is guided onto the joint 24 by deflection mirrors 33, 34, 35 and by a focussing means (not shown in more detail), for example a focussing lens. Alternatively, a fibre optic cable can also be used to reduce the number of parts.

Associated with tension roller 30 is an upper tension roller 36 which has a significantly smaller external diameter than the lower tension roller 30 and is mounted in a freely rotatable manner on a hydraulically operable adjusting cylinder 37 which is attached to an extension arm 38 which, in turn, is mounted on the machine gantry 8. Therefore, the height of the upper tension roller 36 can be adjusted subject to the thickness of the strip 3 to be tensioned.

Drive rollers 39 for conveying the strips 3, 4 to be welded are arranged next to the tension rollers 5, 6. The drive rollers 39 are mounted in at least one bridge-like roller support (not shown). The roller support is movably mounted and is provided with a drive (not shown) by which it can be moved parallel to the axes of rotation of the tension rollers 5, 6, 30, 36. Associated with the roller support is a sensor (seam tracking sensor, not shown) for detecting the position of the strip edges or longitudinal edges to be welded. The sensor signal is delivered to an evaluation unit or control (not shown) which controls the drive of the roller support subject to the detected position of the strip edges or longitudinal edges. If the device according to the invention is to weld strips 3, 4 of a different thickness, a tactile sensor is preferably used as the seam tracking sensor. Alternatively, the signal from the seam tracking sensor can be used to control the laser beam 28. This configuration can be used when there is a small spacing between the welding heads 19, 25 or between the impact points 26, 27 of the energy beams 20, 28. However, a corresponding configuration is also possible where there are greater spacings.

FIGS. 4 and 5 illustrate the basic principle of the sequential welding method according to the invention. A first weld pool region or weld seam region 40 is produced from above on the joint 24 by the first welding head 19. The penetration depth of the weld pool region 40 is approximately 60% of the thickness of the sheet or strip 3, 4, and when sheets or strips 3, 4 of different thicknesses are welded, the proportionate penetration depth is based on the thickness of the thinner sheet/strip. Delayed in time with respect to the first welding procedure of the strips/sheets 3, 4, the second welding procedure then takes place on the lower side of the strips/sheets 3, 4. The penetration depth of the second or lower weld pool region 41 is selected such that it penetrates into the first weld seam region 40. This bilateral welding procedure means that a through-welding of the joint 24 is no longer necessary. Consequently, the loss of laser power can be reduced. In particular, the time-delayed welding according to the invention makes it possible to reduce the energy input. Reduction of the energy input has a positive effect on the strips or sheets 3, 4 to be joined since, as a result, it is possible to restrict the thermal influence zone. In turn, this has an advantageous effect on the mechanical characteristics of the strips or sheets 3, 4 welded in this manner.

To implement the invention, already existing welding installations which are configured, for example, according to DE 37 23 611 C2 can be supplemented by a second welding head 25 together with mounting parts (tension rollers 30, 36, adjusting cylinder 37, extension arm 38) as retrofit equipment.

1-11. (canceled)

12. A device for continuously welding strips or sheets, guided into abutment, at their abutting edges, comprising at least two welding heads, and tension rollers which are arranged in pairs on both sides of the strips or sheets to be welded, perpendicularly to the running direction thereof, and which form a gap in the region of a joint of the strips or sheets, through which gap a first energy beam emanating from a first of the at least two welding heads impacts the strip edges or longitudinal edges to be welded, a second of the at least two welding heads being arranged on the opposite side of the strips or sheets, a second energy beam of said second welding head impacting in this location the strip edges or longitudinal edges to be welded, wherein the at least two welding heads are arranged offset relative to one another in a running direction of the strips or sheets so that the impact points of the energy beams on the strip edges or longitudinal edges to be welded are spaced apart from one another at least by the measurement of half the external diameter of the tension roller facing the first energy beam.

13. The device according to claim 12, wherein the at least two welding heads are arranged such that the impact points of their energy beams on the strip edges or longitudinal edges to be welded are spaced apart from one another by an amount within a range of 15 cm to 200 cm.

14. The device according to claim 12, wherein the tension roller which engages on the lower side of the strips or sheets is configured as a spoked wheel construction and has roller mantles arranged in an axial spacing from one another.

15. The device according to claim 12, wherein arranged next to the tension rollers are roller supports with drive rollers to convey the strips or sheets to be welded.

16. The device according to claim 15, wherein the roller supports are movably mounted and are provided with at least one drive, by which the roller supports can be moved parallel to the axes of rotation of the tension rollers.

17. The device according to claim 16, further comprising least one sensor, connected to a control means, for detecting the position of the strip edges or longitudinal edges to be welded, the control means controlling the at least one drive of the roller supports subject to the position of the strip edges or longitudinal edges, detected by the at least one sensor, or the control means controlling the laser beam.

18. The device according to claim 12, wherein the first of the at least two welding heads is provided in one of the tension rollers arranged on both sides of the strips or sheets, and wherein the second of the at least two welding heads is provided in a tension roller following in the running direction of the strips or sheets.

19. A method for continuously welding strips or sheets, guided into abutment, at their abutting edges, by at least two welding heads, and tension rollers which are arranged in pairs on both sides of the strips or sheets to be welded, perpendicularly to the miming direction thereof, and which form a gap in the region of a joint of the strips or sheets, through which gap a first energy beam emanating from a first of the at least two welding heads impacts the strip edges or longitudinal edges to be welded, a second of the at least two welding heads being arranged on the opposite side of the strips or sheets, a second energy beam of said second welding head impacting in this location the strip edges or longitudinal edges to be welded, wherein the at least two welding heads are arranged offset relative to one another in the miming direction of the strips or sheets so that the impact points of the energy beams on the strip edges or longitudinal edges to be welded are spaced apart from one another at least by the measurement of half the external diameter of the tension roller facing the first energy beam, and wherein the energy beam outputs of the at least two welding heads are adjusted such that the weld pool penetration depth, produced by the respective energy beam, does not extend beyond a partial thickness of the strips or sheets to be welded or, in the case of strips or sheets of different thicknesses, does not extend beyond a partial thickness of the thinner of the strips or sheets to be welded.

20. The method according to claim 19, wherein the energy beam outputs of the welding heads are adjusted such that the weld pool region produced by the second welding head penetrates into the weld seam region produced by the first welding head.

21. The method according to claim 19, wherein the at least two welding heads are operated with a different energy beam output subject to the material, the thickness and/or the feed rate of the strips or sheets to be welded, so that different penetration depths of the weld pool regions are produced on both sides of the strips or sheets to be welded.

22. The method according to claim 19, wherein with the first welding head and the at least one second welding head, Weld pool penetration depths are produced which overlap by at least 10%.
